(19) United States
(12) Patent Application Publication
(10) Pub. No.: US 2011/0042421 A1
(43) Pub. Date: Feb. 24, 2011

(54) Liquid Dispensers

(76) Inventors: Matthew Eric Smith, Isle of Man (GB); Karl Mondszein, Nottinghamshire (GB)

Correspondence Address: ABELMAN, FRAYNE & SCHWAB, 666 THIRD AVENUE, 10TH FLOOR, NEW YORK, NY, 10017, US

(21) Appl. No.: 12/922,804

(22) PCT Filed: Mar. 11, 2009
(86) PCT No.: PCT/GB2009/000665

§ 371 Date: Nov. 4, 2010

(30) Foreign Application Priority Data
Mar. 20, 2008 (GB) 0805282.1

(51) Int. Cl. B67D 3/00

(52) U.S. Cl. 222/518

(57) ABSTRACT

A liquid dispenser includes an outer tube (2) with a discharge opening formed in its side wall and an inner tube (4), which is at least partially accommodated within the outer tube and defines with it an annular space, which accommodates an annular sealing member (20), which forms a peripheral seal with the inner and outer tubes. The other end of the outer tube is adapted for connection to a liquid container. A liquid flow opening (30) is formed in the wall of the inner tube and the inner tube is movable longitudinally within the outer tube between an open position, in which the liquid flow opening communicates with the discharge opening (14), and a closed position, in which the liquid flow path is sealed. An air flow passage with two ends is formed in the inner tube, which is so arranged that when the inner tube is in the open position one of the ends communicates with the discharge opening and the air flow passage.

The present invention relates to liquid dispensers of resealable type, that is to say to devices in the nature of taps that may be selectively opened to dispense a liquid from a container and may then be closed again and will then form a reliable seal and prevent further dispensing of liquid until it is desired. More specifically, the invention relates to a liquid dispenser of the type including an outer tube with a discharge opening formed in its side wall and an inner tube which is at least partially accommodated within the outer tube and defines with it an annular space, which accommodates an annular sealing member which forms a peripheral seal with the inner and outer tubes, one end of the inner tube being closed and one end of the outer tube being integrally connected to the inner tube by a flexible integral web, whose width in the radial direction is greater than that of the annular space, the other end of the outer tube being adapted for connection to a liquid container, a liquid flow opening being formed in the wall of the inner tube, the inner tube being movable longitudinally within the outer tube between an open position, in which the liquid flow opening communicates with the discharge opening and there is a liquid flow path between the said other end of the outer tube and the discharge opening via the liquid flow opening, and a closed position, in which the said liquid flow path is sealed.

A liquid dispenser of the type referred to above is disclosed in WO 2007/020440. The liquid dispenser disclosed in this prior document is in practice intended for containers such as wine boxes, that is to say containers which progressively collapse as their contents are dispensed, which means that as liquid is dispensed from the container it is not replaced by atmospheric air. Whilst there are numerous types of container of this type, there are also numerous types of container which are not collapsible and in which it is therefore necessary for the volume of any liquid displaced to be replaced by atmospheric air. However, the liquid dispenser disclosed in the prior document referred to above is not suitable for this purpose because it is unable to admit air to replace the volume of liquid that is dispensed.

It is therefore the object of the present invention to provide a liquid dispenser of the type referred to above which is suitable for use with a liquid container of non-collapsible type in which it is necessary that air be admitted to replace the volume of liquid that is dispensed.

According to the present invention, a liquid dispenser of the type referred to above is characterised in that an air flow passage with two ends is formed in the inner tube which is so arranged that, when the inner tube is in the open position, one of the ends communicates with the discharge opening and the air flow passage thus bypasses the circumferential seal with the inner tube and that the liquid flow opening and the air flow passage are so positioned that as the inner tube is moved into the open position the liquid flow passage moves into communication with the discharge opening before the said one end of the air flow passage.

Thus in the liquid dispenser in accordance with the present invention, the inner tube is formed not only with a liquid flow opening but also with an air flow passage, the liquid flow opening and the air flow passage being so arranged that as the inner tube is progressively moved towards the open position, the liquid flow opening is the first to move into communication with the discharge opening. When it does so, liquid will immediately begin to flow from the interior of the container through the inner tube and the liquid flow opening to the discharge opening. As it does so, the pressure within the container will rapidly fall. However, as movement of the inner tube towards the open position continues, one end of the air flow passage will move past the peripheral seal with the inner tube and the air flow passage will then bypass the peripheral seal. The said one end of the air flow passage will then communicate with the annular space, which is defined between the inner and outer tubes and communicates with the discharge opening, and since this annular space will necessarily be largely filled with atmospheric air, the reduced pressure in the container will draw air through the air flow passage into the interior of the container, thereby replacing the volume of the liquid that has been dispensed. Thus as dispensing of the liquid proceeds, the volume of the dispensed liquid is replaced by atmospheric air which flows in through the discharge opening in the opposite direction to the discharging liquid and then flows into the annular space and then through the air flow passage into the interior of the container. It will be appreciated that in practice the liquid flow opening will be positioned substantially at the bottom or lowermost portion of the inner tube and that the air flow passage will be situated substantially at the top portion of the inner tube, that is to say at a peripheral position remote from the liquid flow opening and also from the discharge opening in the outer tube.

In other respects, the construction of the liquid dispenser in accordance with the invention may be much the same as that in the prior document referred to above and the manner in which it operates and its advantages are also substantially the same as those in the prior document referred to above.

The air flow passage in the inner tube may take a variety of forms and all that is important is that when the inner tube is in the closed position the air flow passage is positioned so that no air or liquid can flow through it but that when the inner tube is in the open position it bypasses the peripheral seal with the inner tube and thus communicates both with the discharge opening and with the interior of the container and will therefore permit the inflow of air to replace the volume of any liquid that is dispensed. In one embodiment, the air flow passage constitutes a portion of reduced thickness of the inner tube, whereby a depression is formed in its outer surface. When the inner tube is moved to a position in which this depression extends on both sides of the peripheral seal, it will constitute an air flow passage bypassing the peripheral seal. It is, however, rather simpler if the air flow passage constitutes an opening in the inner tube. This opening may be in the nature of a hole or it may be open-sided, that is to say it may communicate with the end of the inner tube and thus constitute effectively a cut-out in its inner end.

It is preferred that, as in the prior document referred to above, the said one end of the inner tube carries a radially projecting flange which engages the said one end of the outer tube, when the inner tube is in the closed position. It is also preferred that the annular web is resilient and exerts a biasing force on the inner tube urging it towards the open position or the closed position, whereby the inner tube is bistableu and, when the flange is in engagement with the said one end of the outer tube, the resilience of the web creates a contact pressure between them.

The annular sealing member may be of U-shaped cross-section and it is preferred that the width of the cross-section increases towards the free ends of the limbs of the U-shaped cross-section. This will result in a seal of high integrity. The sealing member may be moulded integrally with the inner and outer tubes, whereby the entire dispenser may constitute a one-piece injection moulding. Alternatively, the sealing member may constitute a separate component which is press-fitted into the open inner end of the outer tube.

The said other end or inner end of the outer tube is adapted for connection to a liquid container and this connection may be a direct connection, as in the prior document referred to above, that is to say the inner end of the outer tube may carry a screw thread or the like for connection to a liquid container. In an alternative embodiment, the annular sealing member may include a portion of U-shaped cross-section, one limb of which is snap-connected to the said other end of the outer tube and is integral with an annular flange adapted for connection to a liquid container. In this event, the said other end of the outer tube will be connected, in use, indirectly to the liquid container, that is to say via the said limb of the sealing member.

It will be appreciated that it is in practice desirable that the cross-sectional area of the discharge opening is greater than that of the liquid flow opening because this will mean that it will be readily possible, when the inner tube is in the open position, for liquid to flow through the discharge opening in one direction and for air simultaneously to flow through it in the opposite direction to enable the volume of liquid dispensed from the container to be replaced by atmospheric air.

Further features and details of the invention will be apparent from the following description of one specific embodiment which is given by way of example only with reference to the accompanying diagrammatic cross-sectional drawings, in which:

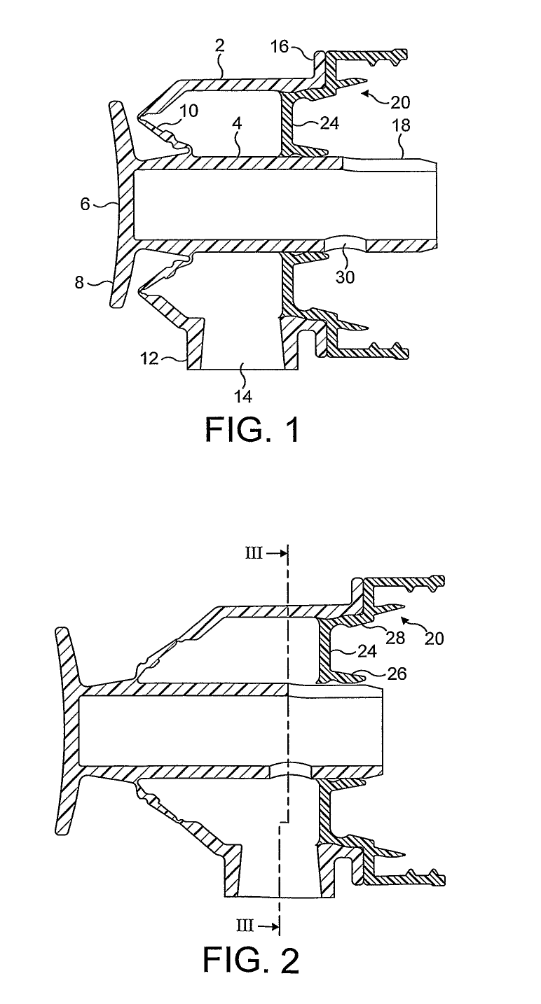

FIG. 1 is an axial sectional view of a dispensing tap in accordance with the invention in the closed or sealed position;

FIG. 2 is a similar view of the tap of FIG. 1 in the open position;

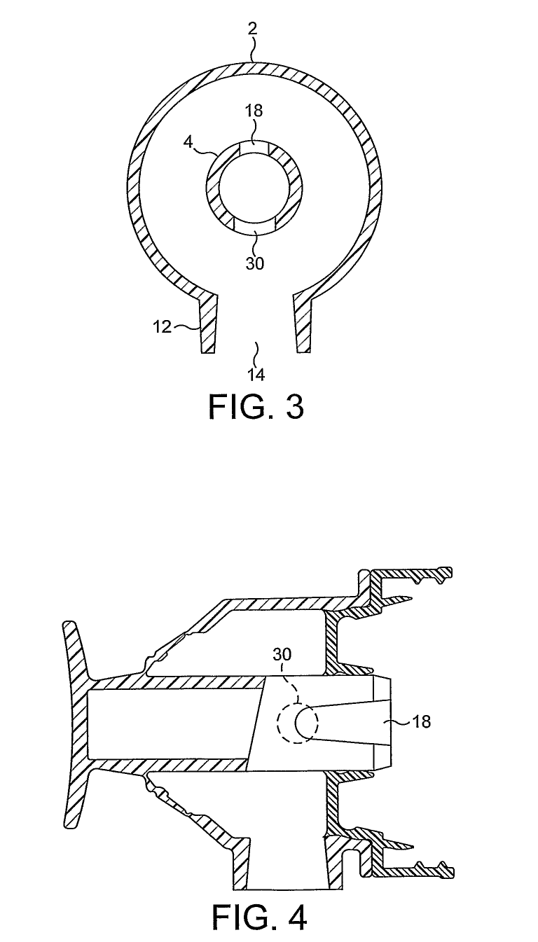

FIG. 3 is a transverse sectional view of the tap of FIGS. 1 and 2 on the line III-III in FIG. 2; and

FIG. 4 is a plan view of the tap of FIGS. 1 to 3 from which the upper portion of the outer tube has been omitted for the sake of clarity.

The dispensing tap illustrated in the Figures includes an outer tube 2, partially accommodated within which is an inner tube 4. One end of the inner tube 4 is closed by a lid 6 which is extended outwardly in the radial direction to constitute a peripheral flange 8. The inner tube 4 is connected at a position on its side wall relatively close to the lid 6 by means of an integral web 10 to the adjacent end of the outer tube 2. This annular web 10 has a dimension in the radial direction which is greater than that of the annular gap defined between the tubes 2 and 4. The web 10 itself and its connections to the tubes 2 and 4 are resilient. At one circumferential position of the outer tube 2, which will be the lowermost position in use, the outer tube 2 is formed with a short depending pipe or spigot 12 which defines a flow opening 14. At its end opposite to the integral web 10, the outer tube 2 is open and is provided with a radially outwardly extending flange 16. Accommodated within this open end of the tube 2 is an annular sealing member 20, which forms a stationary seal with the inner surface of the tube 2 and a sliding seal with the outer surface of the tube 4. Although the sealing member 20 is shown as a separate component, it will be appreciated that it could be moulded integrally with the flange 16. Formed in the lower portion of the wall of the inner tube 4 is a liquid flow opening 30. Formed in the upper portion of the wall of the inner tube 4 is an air flow passage constituted by an elongate open-ended opening or slot 18. As may be seen, the left-hand end of the slot 18 is situated to the right of the left-hand end of the flow opening 30.

As may be seen, the annular sealing member 20 includes a portion of open U-shaped channel section with a base 24 and side limbs 26 and 28. The width of the channel section increases progressively in the direction away from the base 24. The U-shaped portion 20 is so dimensioned that, when in use the position shown in FIGS. 1 and 2, the outer limb 28 has to be deformed inwardly somewhat to accommodate it within the outer tube 2 and the resilience of the material means that the outer limb 28 and the tube 22 engage with a contact pressure which ensures the integrity of the seal between them. As may be seen, the outer surface of the outer limb 28 is irregularly shaped and the inner surface of the outer tube 2 has a complementary irregular shape, whereby these two surfaces are in positive engagement. The U-shaped portion may thus be snap-fitted into position in the open end of the outer tube. Integral with the free end of the outer limb 28 is an annular L-shaped portion, one limb of which extends outwardly over the end of the outer tube 2 and the other limb of which extends in the axial direction and is adapted for connection to a liquid container. In this case, the axially extending limb carries an internal screw thread. In use, the outer tube 2 is thus connected to a liquid container indirectly, that is to say via the axially extending web forming part of the sealing member 20.

Due to the fact that the length of the annular web 10 in the radial direction is greater than the radial dimension of the annular gap defined between the tubes 2 and 4, the inner tube 4 is movable longitudinally with respect to the outer tube 2 between two rest positions in which the web 10 is not deformed. At intermediate positions between these two rest positions, the web 10 is inherently deformed and thus exerts a force on the inner tube 2 tending to move it towards one or other of the rest positions. One of these positions, namely the closed position, is shown in FIG. 1. As may be seen, in this position neither the liquid opening 30 nor the slot 18 communicate with the discharge opening 40 and no liquid may therefore be dispensed. The other rest position is shown in FIG. 2 and in this case the liquid flow opening 30 communicates with the discharge opening 14 and liquid will therefore be dispensed from the container to which the dispenser is connected under the action of gravity. As also seen in FIG. 2, the air flow passage or slot 18 extends from one side of the peripheral seal formed between the limb 26 and the inner tube 4 to the other side of that seal and therefore bypasses the seal. Air may therefore flow inwardly through the discharge opening 14 into the annular space defined between the two tubes and from there through the air passage constituted by the slot 18 into the interior of the container to replace the liquid that is dispensed.

The two positions shown in FIGS. 1 and 2 may be equilibrium positions in which the web 10 is not deformed and thus exerts no force on the tubes. However, the closed equilibrium position of the inner tube 4 may be to the right of that shown in FIG. 1 and indeed may be to the right of the position in which the flange 8 on the inner tube 4 engages the outer tube 2. In this event, the web 10 will still be deformed when in its rest position and the web 10 will still exert a biasing force on the tube 4 acting to the right, as seen in FIG. 1. This would mean that the flange 10 engages the left-hand end of the outer tube 2 under a contact pressure. A bistable arrangement of the inner tube 4 within the outer tube 2 is highly advantageous because as the inner tube 4 is moved to the left, as seen in FIG. 1, the force exerted by the web 10 on the tube 4 will attempt to return it to the closed position. However, once the tube 4 has moved beyond the “top dead centre” position, in which the web 10 extends approximately radially, force exerted by the web 10 on the tube 4 will tend to move it to the left, that is to say into the open position. The tap in accordance with the invention will therefore nearly always be in the fully open position or the fully closed position and it is not possible for the tap to be left in a position in which liquid is allowed to drain at a low rate, albeit inadvertently, from the container.

1. A liquid dispenser including an outer tube (2) with a discharge opening (14) formed in its side wall and an inner tube (4), which is at least partially accommodated within the outer tube (2) and defines with it an annular space, which accommodates an annular sealing member (20) which forms a peripheral seal with the inner and outer tubes, one end of the inner tube (4) being closed (6) and one end of the outer tube (2) being integrally connected to the inner tube (4) by a flexible, integral annular web (10), whose width in the radial direction is greater than that of the annular space, the other end of the outer tube (2) being adapted for connection to a liquid container, a liquid flow opening (30) being formed in the wall of the inner tube (4), the inner tube (4) being movable longitudinally within the outer tube (2) between an open position, in which the liquid flow opening (30) communicates with the discharge opening (14) and there is a liquid flow path between the said other end of the outer tube and the discharge opening (14) via the liquid flow opening (16), and a closed position in which the said liquid flow path is sealed, characterised in that an air flow passage (18) with two ends is formed in the inner tube (4), which is so arranged that when the inner tube (4) is in the open position one of the ends communicates with the discharge opening and the air flow passage thus bypasses the circumferential seal with the inner tube and that the liquid flow opening (30) and the air flow passage (18) are so positioned that as the inner tube is moved into the open position the liquid flow passage moves into communication with the discharge opening before the said one end of the air flow passage.

2. A dispenser as claimed in claim 1 in which the air flow passage constitutes an opening (18) in the inner tube.

3. A dispenser as claimed in claim 1, in which the said one end of the inner tube (4) carries a radially projecting flange (8) which engages the said one end of the outer tube (2), when the inner tube (4) is in the closed position.

4. A dispenser as claimed in claim 3 in which the annular web (10) is resilient and exerts a biasing force on the inner tube (4) urging it towards the open position or the closed position, whereby the inner tube (2) is bistable and, when the flange (8) is in engagement with the said one end of the outer tube (2), the resilience of the web (10) creates a contact pressure between them.

5. A dispenser as claimed in claim 1 in which the annular sealing member (20) is of U-shaped cross-section and the width of the cross-section increases towards the free ends of the limbs (26) of the U-shaped cross-section.

6. A dispenser as claimed in claim 1 in which the annular sealing member includes a portion of U-shaped cross-section, one limb (26) of which is snap-connected to the said other end of the outer tube (2) and is integral with an annular flange (22) adapted for connection to a liquid container whereby, in use, the said other end of the outer tube is indirectly connected to the liquid container.

7. A dispenser as claimed in claim 5, in which the open side of the U-shaped cross-section is directed away from the said one end of the outer tube (2).

8. A dispenser as claimed in claim 1 in which the cross-sectional area of the discharge opening (14) is greater than that of the liquid flow opening (30).
